(19) United States
(12) Patent Application Publication
(10) Pub. No.: US 2017/0044418 A1
(43) Pub. Date: Feb. 16, 2017

(54) HIGH TEMPERATURE STABILIZER FOR POLYMER-BASED TREATMENT FLUIDS

(71) Applicant: SCHLUMBERGER TECHNOLOGY CORPORATION, Sugar Land, TX (US)

(72) Inventors: Wingki LEE, Houston, TX (US); Sergey MAKARYCHEV-MIKHAILOV, Richmond, TX (US); Yenny CHRISTANTI, Houston, TX (US); Syed Afaq ALI, Sugar Land, TX (US)

(21) Appl. No.: 15/306,244

(22) PCT Filed: May 7, 2015
(86) PCT No.: PCT/US2015/029622

§ 371 Date: Oct. 24, 2016

Related U.S. Application Data
(60) Provisional application No. 61/989,819, filed on May 7, 2014.

(51) Int. Cl. C09K 8/035; C09K 8/58; C09K 8/56; C09K 8/62

(52) U.S. Cl. CPC C09K 8/035; C09K 8/62; C09K 8/58; C09K 8/56

(57) ABSTRACT

A method of treating a subterranean formation, the method includes forming a fluid comprising: a crosslinkable component and a water soluble phenolic compound that has at least a substituted hydroxyl or alkyloxy group at the ortho or meta position, or a phenolic cyclic derivative of the general formula (1). The formed fluid comprising a combination of the crosslinkable component and the phenolic compound or the phenolic cyclic derivatives of formula 1 exhibits a fluid viscosity greater than 100 cP at 100/s and 93° C. or greater for at least 30 minutes.

### CROSS-REFERENCE TO RELATED APPLICATION

This international application claims the benefit of U.S. Provisional Patent Application Ser. No. 61/989,819 filed May 7, 2014 entitled “High Temperature Stabilizer for Polymer-based Treatment Fluids” to Lee et al. (Attorney Docket No. IS14.8092-US-PSP), the disclosure of the provisional application is incorporated by reference herein in its entirety.

### BACKGROUND

Hydrocarbons (oil, natural gas, etc.) are obtained from a subterranean geologic formation (a “reservoir”) by drilling a well that penetrates the hydrocarbon-bearing formation. In the process of recovering hydrocarbons from subterranean formations, it is common practice to treat a hydrocarbon-bearing formation with a pressurized fluid to provide flow channels, i.e., to fracture the formation, or to use such fluids to control sand to facilitate flow of the hydrocarbons to the wellbore.

Well treatment fluids, particularly those used in fracturing, may comprise water- or oil-based fluid incorporating a thickening agent, normally a polymeric material. Typical polymeric thickening agents for use in such fluids comprise galactomannan gums, such as guar and substituted guars such as hydroxypropyl guar (HPG) and carboxymethylhydroxypropyl guar (CMHPG). Cellulosic polymers such as hydroxyethyl cellulose or carboxymethyl cellulose (CMC) may also be used, as well as synthetic polymers such as polyacrylamide. Sometimes guar is modified with ionic groups to facilitate hydration of the polymer and to improve crosslinking with metal complexes. Ionic modification of the polymers can reduce the time it takes to dissolve the dry polymer at the well site, and improve both the ultimate gel strength and the thermal persistence of the gel upon crosslinking with a metal crosslinking complex.

As the polymer may degrade within minutes at high temperature (above 93° C.), stabilizers are often used to slow down or stop the degradation so the treatment fluids do not lose viscosity prematurely. In the present disclosure, described are one or more high temperature stabilizers that can improve the stability of metal crosslinked polymer-based fracturing fluids at high temperatures.

The present application relates to fluids used in treating a subterranean formation, such as, for example, the use of polymers in a reservoir having a high temperature. Various types of fluids are used in operations related to the development and completion of wells that penetrate subterranean formations, and to the production of gaseous and liquid hydrocarbons from natural reservoirs into such wells. These operations include perforating subterranean formations, fracturing subterranean formations, modifying the permeability of subterranean formations, or controlling the production of sand or water from subterranean formations. The fluids employed in these oilfield operations are known as drilling fluids, completion fluids, work-over fluids, packer fluids, fracturing fluids, stimulation fluids, conformance or permeability control fluids, consolidation fluids, and the like. Stimulation operations are generally performed in portions of the wells which have been lined with casings, and the purpose of such stimulation is to increase production rates or capacity of hydrocarbons from the formation.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

The statements made merely provide information relating to the present disclosure, and may describe some embodiments illustrating the subject matter of this application.

Described herein is a method for treating a subterranean formation, including forming a fluid comprising: a crosslinkable component and a water soluble phenolic compound that has at least a substituted hydroxyl or alkyloxy group at the ortho or meta position, or a phenolic cyclic derivatives of the general formula (1)

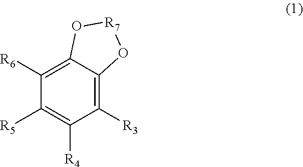

wherein R₇ can be an alkyl chain with 1 to about 5 atoms, which may further incorporate heteroatoms. R₃, R₄, R₅, and R₆ can independently be hydrogen, hydroxyl group, alkyl chain, alkene chain, esters, alcohols, aldehydes, aromatic compound or combinations thereof, and wherein the formed fluid comprising a combination of the crosslinkable component and the phenolic compound or the phenolic cyclic derivatives of formula 1 exhibits a fluid viscosity greater than 100 cP at 100/s and 93° C. or greater for at least 30 minutes.

### BRIEF DESCRIPTION OF DRAWINGS

FIG. 1 is a graphical representation of a rheology profile, according to an embodiment of the disclosure.

FIG. 2 is a graphical representation of a rheology profile, according to an embodiment of the disclosure.

FIG. 3 is a graphical representation of a rheology profile, according to an embodiment of the disclosure.

FIG. 4 is a graphical representation of a rheology profile, according to an embodiment of the disclosure.

FIG. 5 is a graphical representation of a rheology profile, according to an embodiment of the disclosure.

FIG. 6 is a graphical representation of a rheology profile, according to an embodiment of the disclosure.

FIG. 7 is a graphical representation of a rheology profile, according to an embodiment of the disclosure.

FIG. 8 is a graphical representation of a rheology profile, according to an embodiment of the disclosure.

### DETAILED DESCRIPTION

The procedural techniques for pumping fluids down a wellbore to fracture a subterranean formation are well known. The person that designs such treatments is the person of ordinary skill to whom this disclosure is directed. That person has available many useful tools to help design and implement the treatments, including computer programs for simulation of treatments.

At the outset, it should be noted that in the development of any such actual embodiment, numerous implementation-specific decisions may be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary and this detailed description, each numerical value should be read once as modified by the term “about” (unless already expressly so modified), and then read again as not so modified unless otherwise indicated in context. Also, in the summary and this detailed description, it should be understood that a range listed or described as being useful, suitable, or the like, is intended to include support for any conceivable sub-range within the range at least because every point within the range, including the end points, is to be considered as having been stated. For example, “a range of from 1 to 10” is to be read as indicating each possible number along the continuum between about 1 and about 10. Furthermore, one or more of the data points in the present examples may be combined together, or may be combined with one of the data points in the specification to create a range, and thus include each possible value or number within this range. Thus, (1) even if numerous specific data points within the range are explicitly identified, (2) even if reference is made to a few specific data points within the range, or (3) even when no data points within the range are explicitly identified, it is to be understood (i) that the inventors appreciate and understand that any conceivable data point within the range is to be considered to have been specified, and (ii) that the inventors possessed knowledge of the entire range, each conceivable sub-range within the range, and each conceivable point within the range. Furthermore, the subject matter of this application illustratively disclosed herein suitably may be practiced in the absence of any element(s) that are not specifically disclosed herein.

The term “guar” or “guar derivatives” includes any suitable biopolymers, such as for example, hydroxypropyl guar, carboxymethyl guar, carboxymethylhydroxypropyl guar, hydroxyethyl cellulose or carboxymethyl cellulose.

The term “derivative” herein refers, for example, to compounds that are derived from another compound and maintain the same general structure as the compound from which they are derived.

The term “polyacrylamide” includes any suitable polyacrylamide material, such as, but not limited to, polyacrylamide homopolymers, chemical modifications of polyacrylamide such as partially hydrolysed polyacrylamide (PHPA), copolymers of acrylamide such as copolymers of acrylamide and acrylic acid, neutralized copolymers of acrylamide and acrylic acid, copolymers of acrylamide and sodium acrylate, (despite its different source, these copolymers are also commonly known in the industry as partially hydrolyzed polyacrylamide, PHPA), copolymers of acrylamide and AMPS, cationic polyacrylamides, etc. The term “copolymers”, refers and also includes any possible and different compositions and monomer distributions (such as random or block copolymer), or tapered copolymer.

Embodiments of the present application relate to using a water-soluble (e.g., solubility greater than 10 mg/L) phenolic compound that has at least a substituted hydroxyl or alkyloxy group at the ortho or meta position, or a phenolic cyclic derivatives of the general formula (1) (described below) to increase stability of crosslinkable component at high temperatures such as 200 deg F. (93 deg C.) or even 450 deg F. (232 deg C.). Such phenolic compounds likely do not interact with a boronic or metallic crosslinker and therefore may not reverse the polymer crosslinking as described in WO 2010/149954, the disclosure of which is incorporated by reference herein in its entirety.

Specific examples of such a water-soluble phenolic compounds include methoxyphenol, ethoxyphenol, propoxyphenol, butoxyphenol, dimethoxyphenol, trimethoxyphenol, dihydroxy-methoxybenzene, dihydroxy-dimethoxybenzene, trihydroxyphenol, methoxy-methylphenol, allyl methoxyphenol, allyl dimethoxyphenol, rutin hydrate, epigallocatechin, epicatechin, 5-(3′4′5′-trihydroxyphenyl)-γ-valerolactone.

Examples of the phenolic cyclic derivatives are phenols having bridged oxygen atoms of the following general formula (1)

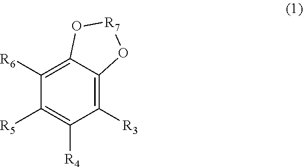

wherein R₇ can be an alkyl chain with 1 to about 5 atoms, which may further incorporate heteroatoms. R₃, R₄, R₅, and R₆ can independently be hydrogen, hydroxyl group, alkyl chain, alkene chain, esters, alcohols, or aldehydes. Specific examples of such phenolic cyclic derivatives are 1,3-benzodioxole, benzo-1,4-dioxane, 2,3-Dihydro-1,4-benzodioxin-5-ol, 5-methoxy-1,3-benzodioxole, 5,6-Dihydroxy-1,3-benzodioxole, sesamol, 5-methyl-1,3-benzodioxole, sesamin, piperonyl alcohol, piperonal, and 3, 4-methylenedioxy aniline.

Thus, a fluid comprising biopolymer or polyacrylamide and a phenol of the formulas defined herein for high temperature stability is useful. The addition of such as phenol increases fluid viscosity of cross-linked fluids at high temperatures such as 93 deg C. or warmer, 162 deg C. or warmer, 176 deg C. or warmer, 204 deg C. or warmer, 218 deg C. or warmer, and 232 deg C. or warmer. Other phenols may have similar stabilizing effect. Using one or more of the phenols defined herein for stability may also benefit fluids comprising bio-polymers such as guar, substituted guars, cellulosic polymers, or other synthetic polymer such as copolymers of acrylamide including acrylamidomethylpropane sulfonate (AMPS) and vinylpyrrolidone. Potential applications of such fluid systems can be extended from fracturing to other treatments such as sand control, water control, drilling and cementing.

In embodiments, the phenolic compounds were used alone and did not contain chitosan-based compounds or aldehyde, and therefore no crosslinking is expected to occur with the phenolic compounds.

In some embodiments, the phenolic compounds described herein may be present in the treatment fluid in an amount from about 10 mg/L to about 100 g/L

While the treatment fluids of the present disclosure are described herein as comprising the above-mentioned components, it should be understood that the fluids of the present disclosure may optionally comprise other chemically different materials. Furthermore, the components of the treatment fluid described in detail above (or an entirely different treatment fluid such that one or more different treatment fluids are used to treat the formation) may include a linear or crosslinked gel. Furthermore, if the gel is crosslinked, it may also contain a crosslinkable component, a carrier fluid and a crosslinker.

The treatment fluids or compositions suitable for use in the methods of the present disclosure comprise a crosslinkable component. As discussed above, a “crosslinkable component,” as the term is used herein, is a compound and/or substance that comprises a crosslinkable moiety. However, the crosslinkable components can be used without the presence of a crosslinker. In this case, the gel form would be a linearized gel instead of a crosslinked gel. For example, the crosslinkable components may contain one or more crosslinkable moieties, such as a carboxylate and/or a cis-hydroxyl (vicinal hydroxyl) moiety that is able to coordinate with the reactive sites of the crosslinker. The reactive sites of the crosslinkable component may be, for example, the site where the metals (such as Al, Zr and Ti and/or other Group IV metals) and/or boron are present. The crosslinkable component may be natural or synthetic polymers (or derivatives thereof) that comprise a crosslinkable moiety, for example, substituted galactomannans, guar gums, high-molecular weight polysaccharides composed of mannose and galactose sugars, or guar derivatives, such as hydrophobically modified guars, guar-containing compounds, and synthetic polymers. Suitable crosslinkable components may comprise a guar gum, a locust bean gum, a tara gum, a honey locust gum, a tamarind gum, a karaya gum, an arabic gum, a ghatti gum, a tragacanth gum, a carrageenan, a succinoglycan, a xanthan, a diutan, a hydroxylethylguar. a hydroxypropyl guar, a carboxymethylhydroxyethyl guar, a carboxymethylhydroxypropylguar, a carboxyalkyl cellulose, such as carboxymethyl cellulose (CMC) or carboxyethyl cellulose, an alkylcarboxyalkyl cellulose, an alkyl cellulose, an alkylhydroxyalkyl cellulose, a carboxyalkyl cellulose ether, a hydroxyethylcellulose, a carboxymethylhydroxyethyl cellulose, a carboxymethyl starch, a copolymer of 2-acrylamido-2-methyl-propane sulfonic acid and acrylamide, a terpolymer of 2-acrylamido-2-methyl-propane sulfonic acid, acrylic acid, acrylamide, or derivatives thereof. In embodiments, the crosslinkable components may be present at about 0.01% to about 4.0% by weight based on the total weight of the treatment fluid, such as at about 0.10% to about 2.0% by weight based on the total weight of the treatment fluid.

The treatment fluid of the present disclosure may be a solution initially having a very low viscosity that can be readily pumped or otherwise handled. For example, the viscosity of the fluid may be from about 1 cP to about 10,000 cP, or be from about 1 cP to about 1,000 cP, or be from about 1 cP to about 100 cP at the treating temperature, which may range from a surface temperature to a bottom-hole static (reservoir) temperature, such as from about 4° C. to 2° C. to about 246° C., or from about 10° C. to about 149° C., or from about 25° C. to about 121° C., or from about 32° C. to about 107° C.

Crosslinking the fluid of the present disclosure generally increases its viscosity. As such, having the composition in the uncrosslinked/unviscosified state allows for pumping of a relatively less viscous fluid having relatively low friction pressures within the well tubing, and the crosslinking may be delayed in a controllable manner such that the properties of thickened crosslinked fluid are available at the rock face instead of within the wellbore. Such a transition to a crosslinked/uncrosslinked state may be achieved over a period of minutes or hours based on the particular molecular make-up of the crosslinker, and results in the initial viscosity of the treatment fluid increasing by at least an order of magnitude, such as at least two orders of magnitude.

Once crosslinked, the formed fluid comprising a combination of the crosslinkable component and the phenolic compound or the phenolic cyclic derivatives of formula 1 may exhibit a fluid viscosity greater than 100 cP at 100/s and 93° C. or greater for at least 30 minutes. For example, the fluid viscosity may be greater than 200 cP, greater than 300 cP, greater than 500 cP or greater than 1000 cP, each measured at 100/s and 93° C. or greater. The fluid viscosity may be maintained at the above viscosities for a period for at least 30 minutes, such as, for example, from about 30 minutes to about 1 hour.

Suitable solvents for use with the fluid in the present disclosure may be aqueous or organic based. Aqueous solvents may include at least one of fresh water, sea water, brine, mixtures of water and water-soluble organic compounds and mixtures thereof. Organic solvents may include any organic solvent which is able to dissolve or suspend the various components of the treatment fluid, such as, for example, organic alcohols, such as, isopropanol.

In some embodiments, the treatment fluid may initially have a viscosity similar to that of the aqueous solvent, such as water. An initial water-like viscosity may allow the solution to effectively penetrate voids, small pores, and crevices, such as encountered in fine sands, coarse silts, and other formations. In other embodiments, the viscosity may be varied to obtain a desired degree of flow sufficient for decreasing the flow of water through or increasing the load-bearing capacity of a formation. The rate at which the viscosity of the treatment fluid changes may be varied by the choice of the crosslinker and polymer employed in the treatment fluid. The viscosity of the treatment fluid may also be varied by increasing or decreasing the amount of solvent relative to other components, or by other techniques, such as by employing viscosifying agents. In embodiments, the solvent, such as an aqueous solvent, may represent up to about 95 weight percent of the treatment fluid, such as in the range of from about 85 to about 95 weight percent of the treatment fluid, or from about 90 to about 95 weight percent of the treatment fluid.

In some embodiments, the treatment fluid may initially have a viscosity similar to that of the aqueous solvent, such as water or a more viscous base fluid formed by a linear polymer gel. Viscosity can be increased further by formation of a foam or energized fluid in the wellbore.

The crosslinking agent in the treatment fluids of the present application may comprise a polyvalent metal ion that is capable of crosslinking at least two molecules of the crosslinkable component. Examples of suitable metal ions include, but are not limited to, zirconium IV, titanium or aluminum and/or other Group IV metals. Other suitable crosslinkers can contain boron. The metal ions may be provided by any compound that is capable of producing one or more of these ions. Examples of such compounds include zirconyl chloride, zirconium sulfate and triethanol titanate.

In some embodiments, the crosslinking agent is present in the treatment fluid in an amount from about 0.1 to about 1.0% by volume. In some embodiments, the crosslinking agent comprises about 0.3% by volume of the fluid. Considerations one may take into account in deciding how much crosslinking agent may be added include the temperature conditions of a particular application, the composition of the gelling agent used, and/or the pH of the treatment fluid. Other considerations may be evident to one skilled in the art.

The crosslinking agent may also comprise a stabilizing agent operable to provide sufficient stability to allow the crosslinking agent to be uniformly mixed into the polymer solution. Examples of suitable stabilizing agents include, but are not limited, to propionate, acetate, formate, triethanolamine, and triisopropanolamine Additional stabilizing agents are discussed below.

The treatment fluid may not begin to build viscosity before it is placed into the desired portion of a subterranean formation. If it builds viscosity too quickly, this would interfere with pumping and placement of the crosslinkable polymer composition into the formation. However, for some particular crosslinkers, such as, for example, dual-metal crosslinkers, the viscosity may be developed early for sufficient proppant transport prior to entering the formation.

As discussed above, a treatment fluid comprised of at least a crosslinkable component, a carrier fluid and a crosslinkable material may be introduced into the subterranean formation. At some point in the subterranean formation, the crosslinkable component and the crosslinkable material may crosslink to form a gelled fluid, thus resulting in a fracture in the subterranean formation.

In embodiments, the fluid may further comprise stabilizing agents, surfactants, diverting agents, or other additives. Additionally, the treatment fluid may comprise a mixture of various other crosslinking agents, and/or other additives, such as fibers or fillers, provided that the other components chosen for the mixture are compatible with the intended use of forming a crosslinked three dimensional structure that at least partially transports proppant. In embodiments, the treatment fluid of the present disclosure may further comprise one or more components such as, for example, a gel breaker, a buffer, a proppant, a clay stabilizer, a gel stabilizer, and a bactericide. Furthermore, the treatment fluid or treatment fluid may comprise buffers, pH control agents, oxygen scavengers and various other additives added to promote the stability or the functionality of the fluid. The treatment fluid may be based on an aqueous or non-aqueous solution. The components of the treatment fluid may be selected such that they may or may not react with the subterranean formation that is to be fractured.

In this regard, the treatment fluid may include components independently selected from any solids, liquids, gases, and combinations thereof, such as slurries, gas-saturated or non-gas-saturated liquids, mixtures of two or more miscible or immiscible liquids, and the like, as long as such additional components allow for the formation of a three dimensional structure upon substantial completion of the crosslinking reaction. For example, the fluid or treatment fluid may comprise organic chemicals, inorganic chemicals, and any combinations thereof. Organic chemicals may be monomeric, oligomeric, polymeric, crosslinked, and combinations, while polymers may be thermoplastic, thermosetting, moisture setting, elastomeric, and the like. Inorganic chemicals may be metals, alkaline and alkaline earth chemicals, minerals, and the like. Fibrous materials may also be included in the fluid or treatment fluid. Suitable fibrous materials may be woven or nonwoven, and may be comprised of organic fibers, inorganic fibers, mixtures thereof and combinations thereof.

Stabilizing agents can be added to slow the degradation of the crosslinked structure after its formation downhole. Typical stabilizing agents include buffering agents, such as water-soluble bicarbonate salts, such as sodium bicarbonate, carbonate salts, phosphate salts, or mixtures thereof, among others; and chelating agents (such as ethylenediaminetetraacetic acid (EDTA), nitrilotriacetic acid (NTA), or diethylenetriaminepentaacetic acid (DTPA), hydroxyethylethylenediaminetriacetic acid (HEDTA), or hydroxyethyliminodiacetic acid (HEIDA), among others), which may or may not be the same as used for the coordinated ligand system of the chelated metal of the crosslinker.

Buffering agents may be added to the treatment fluid in an amount from about 0.05 wt. % to about 10 wt. %, and from about 0.1 wt. % to about 2 wt. %, based upon the total weight of the treatment fluid. Additional chelating agents may be added to the fluid or treatment fluid to at least about 0.75 mole per mole of metal ions expected to be encountered in the downhole environment, such as at least about 0.9 mole per mole of metal ions, based upon the total weight of the fluid or treatment fluid.

Surfactants can be added to promote dispersion or emulsification of components of the fluid, or to provide foaming of the crosslinked component upon its formation downhole. Suitable surfactants include alkyl polyethylene oxide sulfates, alkyl alkylolamine sulfates, modified ether alcohol sulfate sodium salts, or sodium lauryl sulfate, among others. Any surfactant which aids the dispersion and/or stabilization of a gas component in the fluid to form an energized fluid can be used. Viscoelastic surfactants, such as those described in U.S. Pat. No. 6,703,352, U.S. Pat. No. 6,239,183, U.S. Pat. No. 6,506,710, U.S. Pat. No. 7,303,018, U.S. Pat. No. 6,482,866, U.S. Pat. No. 7,998,909 and U.S. Pat. No. 8,207,094, each of which are incorporated by reference herein in their entirety, are also suitable for use in fluids in some embodiments. Examples of suitable surfactants also include, but are not limited to, amphoteric surfactants or zwitterionic surfactants. Alkyl betaines, alkyl amido betaines, alkyl imidazolines, alkyl amine oxides and alkyl quaternary ammonium carboxylates are some examples of zwitterionic surfactants. An example of a useful surfactant is the amphoteric alkyl amine contained in the surfactant solution AQUAT 944 (available from Baker Petrolite of Sugar Land, Tex.). A surfactant may be added to the fluid in an amount in the range of about 0.01 wt. % to about 10 wt. %, such as about 0.1 wt. % to about 2 wt. % based upon total weight of the treatment fluid.

Charge screening surfactants may be employed. In some embodiments, the anionic surfactants such as alkyl carboxylates, alkyl ether carboxylates, alkyl sulfates, alkyl ether sulfates, alkyl sulfonates, a-olefin sulfonates, alkyl ether sulfates, alkyl phosphates and alkyl ether phosphates may be used. Anionic surfactants have a negatively charged moiety and a hydrophobic or aliphatic tail, and can be used to charge screen cationic polymers. Examples of suitable ionic surfactants also include, but are not limited to, cationic surfactants such as alkyl amines, alkyl diamines, alkyl ether amines, alkyl quaternary ammonium, dialkyl quaternary ammonium and ester quaternary ammonium compounds. Cationic surfactants have a positively charged moiety and a hydrophobic or aliphatic tail, and can be used to charge screen anionic polymers such as CMHPG.

The treatment fluids described herein may also include one or more inorganic salts. Examples of these salts include water-soluble potassium, sodium, and ammonium salts, such as potassium chloride, ammonium chloride, choline chloride, or tetramethyl ammonium chloride (TMAC). Additionally, sodium chloride, calcium chloride, potassium chloride, sodium bromide, calcium bromide, potassium bromide, sodium sulfate, calcium sulfate, sodium phosphate, calcium phosphate, sodium nitrate, calcium nitrate, cesium chloride, cesium sulfate, cesium phosphate, cesium nitrate, cesium bromide, potassium sulfate, potassium phosphate, potassium nitrate salts may also be used. Any mixtures of the inorganic salts may be used as well. The inorganic salt may be added to the fluid in an amount of from about 1 wt % to about 99 wt. % based upon total weight of the treatment fluid.

In other embodiments, the surfactant is a blend of two or more of the surfactants described above, or a blend of any of the surfactant or surfactants described above with one or more nonionic surfactants. Examples of suitable nonionic surfactants include, but are not limited to, alkyl alcohol ethoxylates, alkyl phenol ethoxylates, alkyl acid ethoxylates, alkyl amine ethoxylates, sorbitan alkanoates and ethoxylated sorbitan alkanoates. Any effective amount of surfactant or blend of surfactants may be used in aqueous energized fluids.

Friction reducers may also be incorporated in any fluid embodiment. Any suitable friction reducer polymer, such as polyacrylamide and copolymers, partially hydrolyzed polyacrylamide, poly(2-acrylamido-2-methyl-1-propane sulfonic acid) (polyAMPS), and polyethylene oxide may be used. Commercial drag reducing chemicals such as those sold by Conoco Inc. under the trademark “CDR” as described in U.S. Pat. No. 3,692,676 or drag reducers such as those sold by Chemlink designated under the trademarks FLO1003, FLO1004, FLO1005 and FLO1008 have also been found to be effective. These polymeric species added as friction reducers or viscosity index improvers may also act as excellent fluid loss additives reducing or even eliminating the use of conventional fluid loss additives. Latex resins or polymer emulsions may be incorporated as fluid loss additives. Shear recovery agents may also be used in embodiments.

The above fluids may also comprise a breaker. The purpose of this component is to “break” or diminish the viscosity of the fluid so that this fluid is more easily recovered from the formation during cleanup. With regard to breaking down viscosity, inorganic or organic oxidizers, enzymes, or acids may be used. Breakers reduce the polymer's molecular weight by the action of an acid, an oxidizer, an enzyme, or some combination of these on the polymer itself In the case of borate-crosslinked gels, increasing the pH and therefore increasing the effective concentration of the active crosslinker, the borate anion, reversibly create the borate crosslinks. Lowering the pH can just as easily remove the borate/polymer bonds. At a high pH above 8, the borate ion exists and is available to crosslink and cause gelling. At lower pH, the borate is tied up by hydrogen and is not available for crosslinking, thus gelation by borate ion is reversible.

Embodiments may also include proppant particles that are substantially insoluble in the fluids of the formation. Proppant particles carried by the treatment fluid remain in the fracture created, thus propping open the fracture when the fracturing pressure is released and the well is put into production. Proppant particles can have any shape, including but not limited to spherical and rod-like. Proppant particles might be filled entirely with a solid substrate or contain hollow spaces within. Suitable proppant materials include, but are not limited to, sand, walnut shells, sintered bauxite, glass beads, ceramic materials, nanocomposite beads, naturally occurring materials, or similar materials. Mixtures of proppants can be used as well. If sand is used, it may be from about 20 to about 100 U.S. Standard Mesh in size, although other sizes above and below this range can be used. With synthetic proppants, mesh sizes about 8 or greater may be used. Naturally occurring materials may be underived and/or unprocessed naturally occurring materials, as well as materials based on naturally occurring materials that have been processed and/or derived. Suitable examples of naturally occurring particulate materials for use as proppants include: ground or crushed shells of nuts such as walnut, coconut, pecan, almond, ivory nut, brazil nut, etc.; ground or crushed seed shells (including fruit pits) of seeds of fruits such as plum, olive, peach, cherry, apricot, etc.; ground or crushed seed shells of other plants such as maize (e.g., corn cobs or corn kernels), etc.; processed wood materials such as those derived from woods such as oak, hickory, walnut, poplar, mahogany, etc. including such woods that have been processed by grinding, chipping, or other form of particulation, processing, etc.

The concentration of proppant in the fluid can be any concentration known in the art. For example, the concentration of proppant in the fluid may be in the range of from about 0.03 to about 3 kilograms of proppant added per liter of liquid phase. Also, any of the proppant particles can further be coated with a resin to potentially improve the strength, clustering ability, and flow back properties of the proppant.

A fiber component may be included in the fluids to achieve a variety of properties including improving particle suspension, and particle transport capabilities, and gas phase stability. Fibers used may be hydrophilic or hydrophobic in nature. Fibers can be any fibrous material, such as, for example, natural organic fibers, comminuted plant materials, synthetic polymer fibers (by non-limiting example polyester, polyaramide, polyamide, novoloid or a novoloid-type polymer), fibrillated synthetic organic fibers, ceramic fibers, inorganic fibers, metal fibers, metal filaments, carbon fibers, glass fibers, ceramic fibers, natural polymer fibers, and any mixtures thereof. Particularly useful fibers are polyester fibers coated to be highly hydrophilic, such as, but not limited to, DACRON polyethylene terephthalate (PET) Fibers available from Invista Corp. Wichita, Kans. USA, 67220. Other examples of useful fibers include, but are not limited to, polylactic acid polyester fibers, polyglycolic acid polyester fibers, polyvinyl alcohol fibers, and the like. When used in fluids, the fiber component may be included at concentrations from about 1 to about 100 grams per liter of the liquid phase of the fluid, such as a concentration of fibers from about 2 to about 30 grams per liter of liquid, or from about 2 to about 20 grams per liter of liquid.

Embodiments may further use fluids containing other additives and chemicals that are known to be commonly used in oilfield applications by those skilled in the art. These include materials such as surfactants in addition to those mentioned hereinabove, breaker aids in addition to those mentioned hereinabove, oxygen scavengers, alcohol stabilizers, scale inhibitors, corrosion inhibitors, fluid-loss additives, bactericides and biocides such as 2,2-dibromo-3-nitrilopropionamine or glutaraldehyde, and the like. Also, they may include a co-surfactant to optimize viscosity or to minimize the formation of stable emulsions that contain components of crude oil.

As used herein, the term “alcohol stabilizer” is used in reference to a certain group of organic molecules substantially or completely soluble in water containing at least one hydroxyl group, which are susceptible of providing thermal stability and long term shelf life stability to aqueous zirconium complexes. Examples of organic molecules referred as “alcohol stabilizers” include but are not limited to methanol, ethanol, n-propanol, isopropanol, n-butanol, tert-butanol, ethyleneglycol monomethyl ether, and the like.

Furthermore, one or more of the chemicals identified above may be encapsulated to provide a delayed release of the oilfield chemicals into the surrounding fluid or material such that the oilfield chemical is liberated after entering the formation (or the fracture). Additional details regarding encapsulation are described in U.S. Patent Application Pub. Nos. 2010/0307744; 20100270031 and 2008/0109490, the disclosures of which are incorporated by reference herein in their entirety.

Conventional propped hydraulic fracturing techniques, with appropriate adjustments if needed, as will be apparent to those skilled in the art, are used in some methods described herein. One fracture stimulation treatment begins with a conventional pad stage to generate the fracture, followed by a sequence of stages in which a viscous carrier fluid transports proppant into the fracture as the fracture is propagated. In this sequence of stages the amount of propping agent is increased, normally stepwise. The pad and carrier fluid can be a fluid of adequate viscosity. The pad and carrier fluids may contain various additives. Non-limiting examples are fluid loss additives, crosslinking agents, clay control agents, breakers, iron control agents, and the like, provided that the additives do not affect the stability or action of the fluid.

### EXAMPLES

The following examples are presented to illustrate the preparation and properties of fluid systems, and should not be construed to limit the scope of the present application, unless otherwise expressly indicated in the appended claims. All percentages, concentrations, ratios, parts, etc. are by weight unless otherwise noted or apparent from the context of their use.

Each of the formulations tested were prepared by hydrating the polymer in tap water with an overhead mixer at 500-1000 rpm for at least 10 mins. Then, desired amounts of zirconium crosslinker and temperature stabilizers were added to the hydrated polymer.

To measure viscosity of the solutions, 50 mL samples were loaded into a rheometer cup in a Grace M5600 rheometer. The cup was attached a coquette-style rheometer with a R1-B5 configuration. The rheology tests were performed with American Petroleum Institure (API) ramping sequence, where a shear rate of 100/s with periodic shear-rate ramps of 100, 75, 50, 25, 50, 75, 100/s every 20 minutes were applied. All tests were performed under at least 500 psi to avoid sample from boiling.

### Example 1

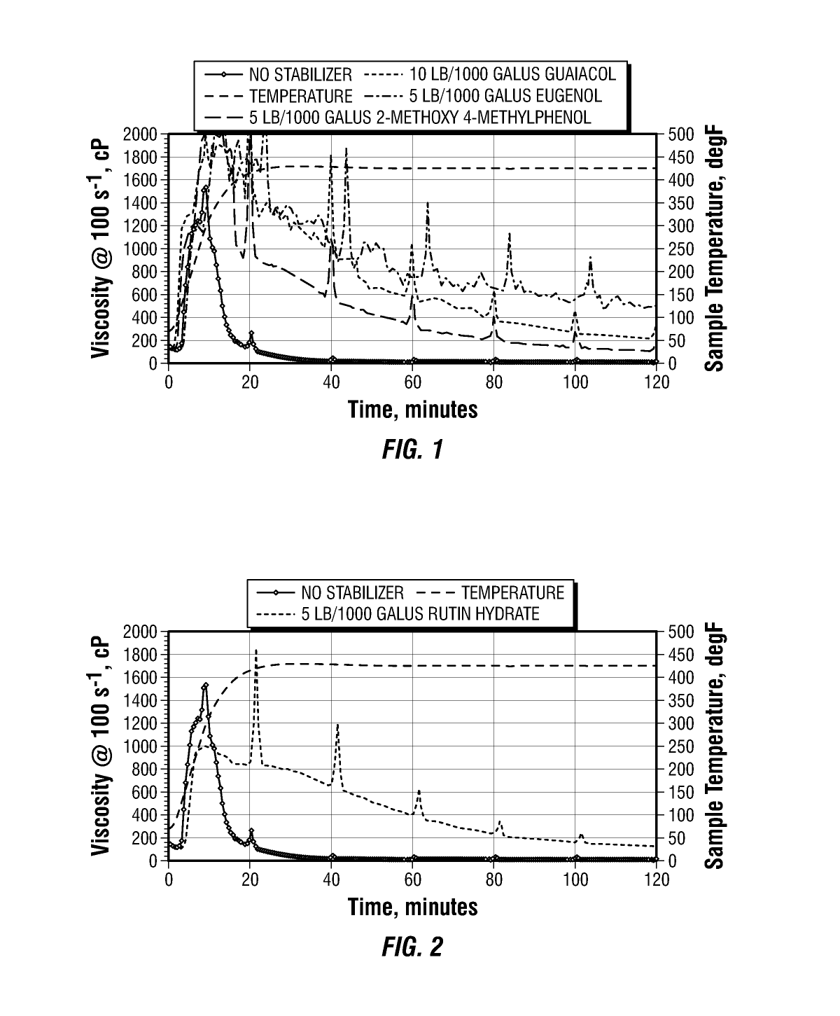

5 mL/L of a zirconium crosslinker was added to a 6.3 g/L of a hydrated linear polymer gel based on polyacrylamide co-polymer. 0.6 g/L eugenol, 1.2 g/L guaiacol, or 0.6 g/L 2-methoxy-4-methylphenol was also added to the solution. The viscosity of the sample was measured at 218° C. (425° F.). The results for Example 1 are shown in FIG. 1.

As shown in FIG. 1, the gel without the phenol stabilizer had viscosity less than 100 cP at 100/s and 218° C. in less than 30 mins. The same gel in presence of any one of the three phenol stabilizers used in Example 1 (guaiacol, eugenol, or 2-methoxy 4-methylphenol, which have a substituted hydroxyl- or alkyloxy group at the ortho or meta position of a phenolic compound demonstrated sufficient thermal stability with time by having a viscosity greater than 100 cP at 100/s and 218° C. in 2 hours.

### Example 2

5 mL/L of a zirconium crosslinker was added to a 6.3 g/L of a hydrated linear polymer gel based on polyacrylamide co-polymer. 0.6 g/L rutin hydrate was also added to the solution to compare with the one without stabilizer. The viscosity of the sample was measured at 218° C. (425° F.). The results for Example 2 are shown in FIG. 2.

As shown in FIG. 2, the gel without the phenol stabilizer had viscosity less than 100 cP at 100/s and 218° C. in less than 30 mins. The same gel in presence rutin hydrate in Example 2, which has a substituted hydroxyl- or alkyloxy group at the ortho or meta position of a phenolic compound demonstrated sufficient thermal stability with time by having a viscosity greater than 100 cP at 100/s and 218° C. in 2 hours.

### Example 3

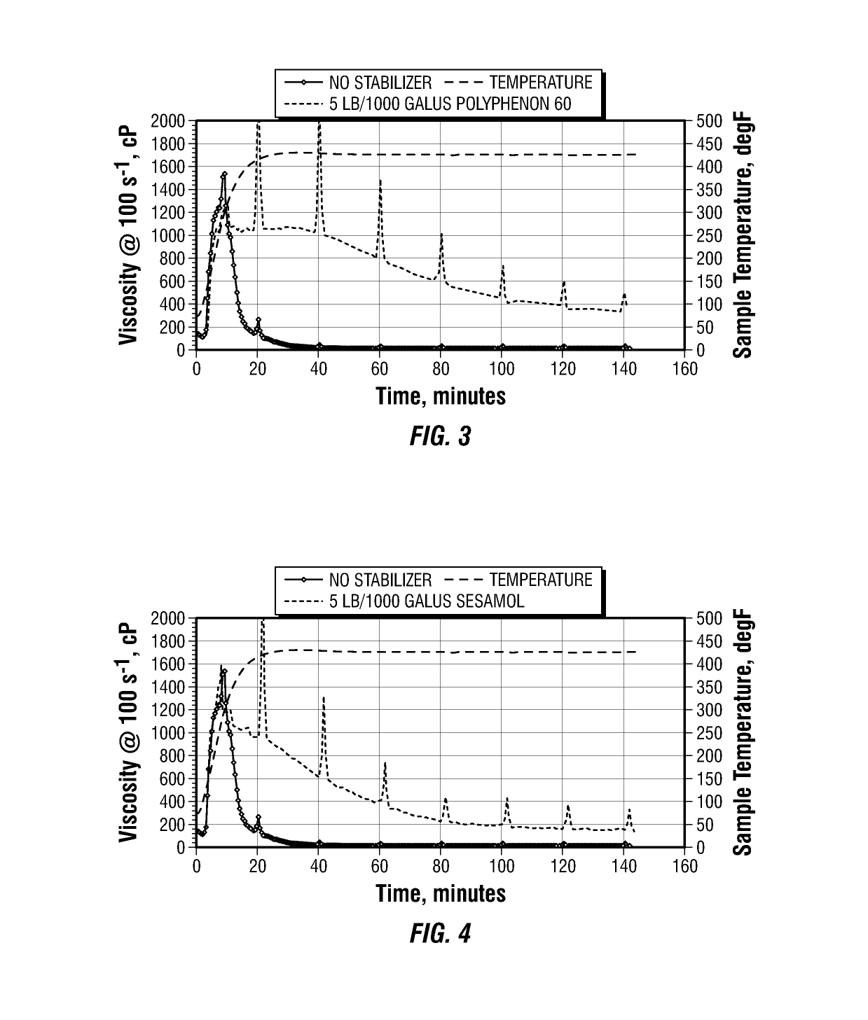

5 mL/L of a zirconium crosslinker was added to a 6.3 g/L of a hydrated linear polymer gel based on polyacrylamide co-polymer. 0.6 g/L polyphenon 60 was also added to the solution to compare with the one without stabilizer. The viscosity of the sample was measured at 218° C. (425° F.). The results for Example 3 are shown in FIG. 3.

As shown in FIG. 3, the gel without the phenol stabilizer had viscosity less than 100 cP at 100/s and 218° C. in less than 30 mins. The same gel in presence of the phenol stabilizer used in Example 3 (polyphenon 60), which has a substituted hydroxyl- or alkyloxy group at the ortho or meta position of a phenolic compound demonstrated sufficient thermal stability with time by having a viscosity greater than 100 cP at 100/s and 218° C. in 2 hours.

### Example 4

5 mL/L of a zirconium crosslinker was added to a 6.3 g/L of a hydrated linear polymer gel based on polyacrylamide co-polymer. 0.6 g/L sesamol was also added to the solution to compare with the one without stabilizer. The viscosity of the sample was measured at 218° C. (425° F.). The results for Example 4 are shown in FIG. 4.

As shown in FIG. 4, the gel without the phenol stabilizer had viscosity less than 100 cP at 100/s and 218° C. in less than 30 mins. The same gel in presence of the phenol stabilizer used in Example 4 (sesamol), which has a sub-unit of general formula of (1) demonstrated sufficient thermal stability with time by having a viscosity greater than 100 cP at 100/s and 218° C. in 2 hours.

### Example 5

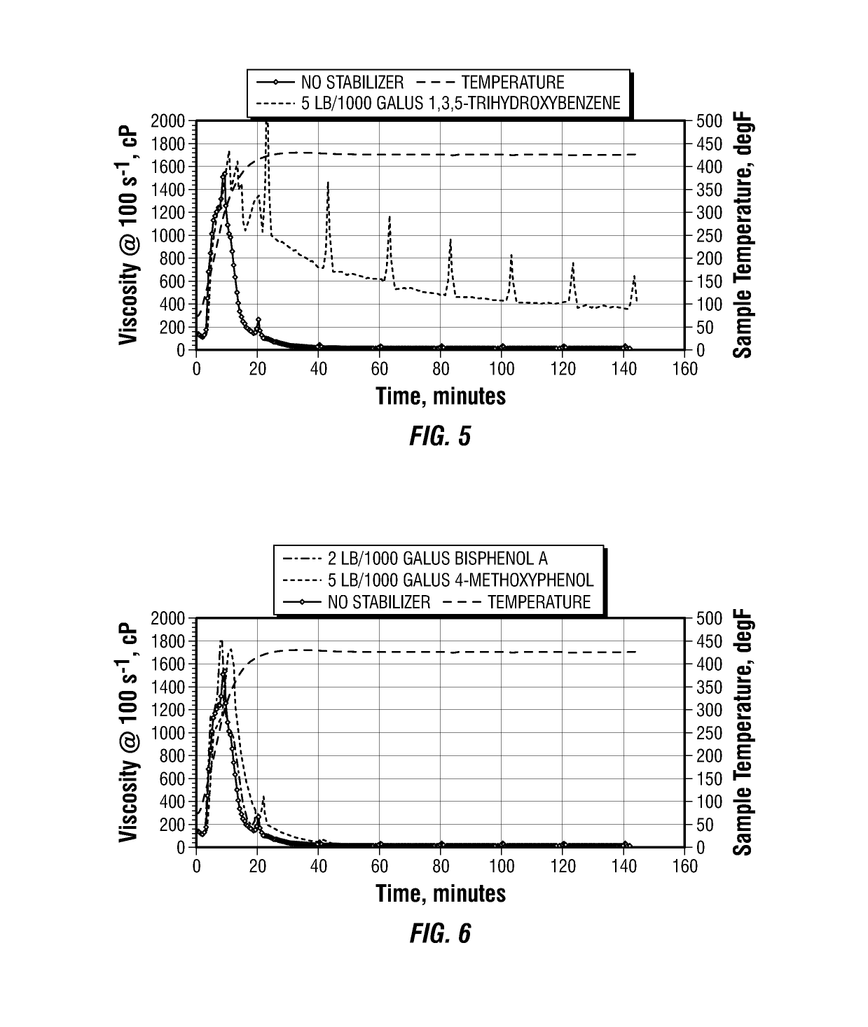

5 mL/L of a zirconium crosslinker was added to a 6.3 g/L of a hydrated linear polymer gel based on polyacrylamide co-polymer. 0.6 g/L 1,3,5-trihydroxybenzene was also added to the solution to compare with the one without stabilizer. The viscosity of the sample was measured at 218° C. (425° F.). The results for Example 5 are shown in FIG. 5.

As shown in FIG. 5, the gel without the phenol stabilizer had viscosity less than 100 cP at 100/s and 218° C. in less than 30 mins. The same gel in presence of the phenol stabilizer used in Example 5 (1,3,5-trihydroxybenzene ihydrate, which has a substituted hydroxyl- or alkyloxy group at the ortho or meta position of a phenolic compound demonstrated sufficient thermal stability with time by having a viscosity greater than 100 cP at 100/s and 218° C. in 2 hours.

### Comparative Example 1

5 mL/L of a zirconium crosslinker was added to a 6.3 g/L of a hydrated linear polymer gel based on polyacrylamide co-polymer. 0.24 g/L bisphenol A or 0.6 g/L 4-methoxyphenol was also added to the solution to compare with the one without stabilizer. The viscosity of the sample was measured at 218° C. (425° F.). The results for Comparative Example 1 are shown in FIG. 6.

As shown above in FIG. 6, the gel without the phenol stabilizer had viscosity less than 100 cP at 100/s and 218° C. in less than 30 mins. The same gel in presence of the phenol stabilizers used in Comparative Example 1 (4-Methoxyphenol or Bisphenol A) did not demonstrate a sufficient thermal stability with time by having a viscosity greater than 100 cP at 100/s and 218° C. in 2 hours.

### Example 6

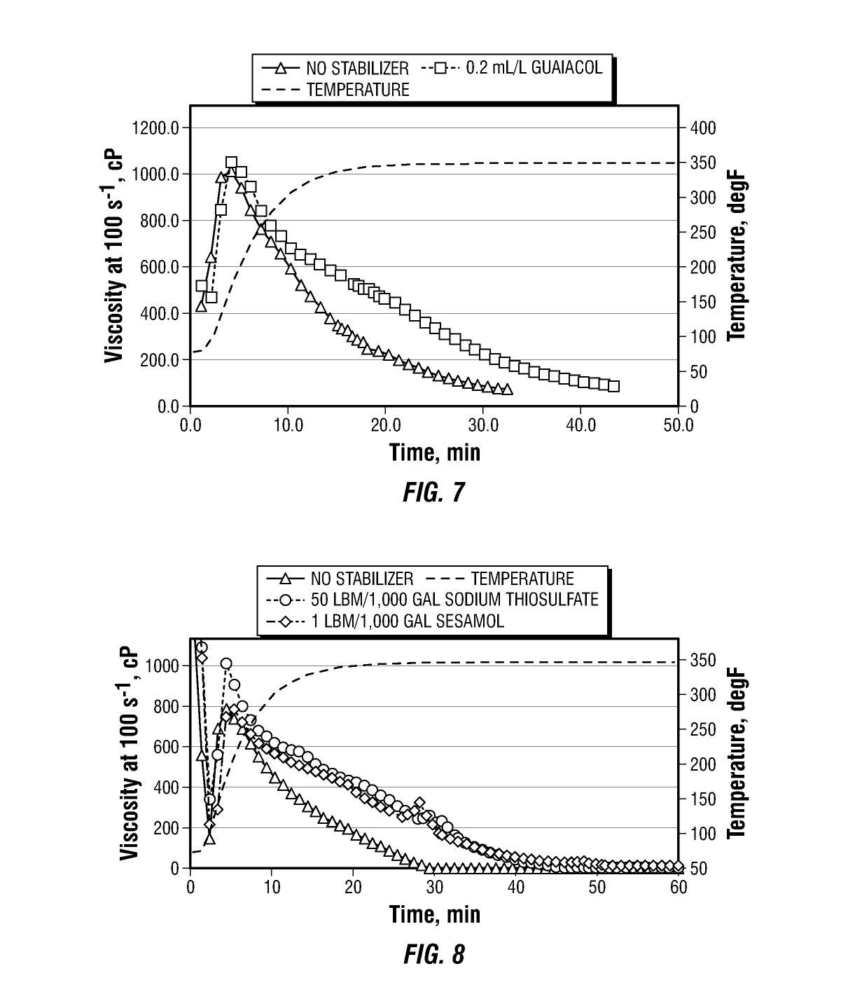

1.5 mL/L of a zirconium crosslinker was added to a 6.3 g/L of a hydrated linear polymer gel based on 6 g/L CMHPG, 2 weight percent of potassium chloride (KCl), 2 mL/L surfactant and 1 mL/L of tetraethylene pentamine (TEPA). 0.2 mL/L guaiacol was also added to the solution to compare with the one without stabilizer. The viscosity of the sample was measured at 177° C. (350° F.). The results for Example 6 are shown in FIG. 7.

As shown in FIG. 7, the gel without the phenol stabilizer had viscosity less than 50 cP at 100/s and 177° C. in less than 30 mins (about 26 minutes). The same gel in presence of the phenol stabilizer used in Example 8 (guaiacol), which has a substituted hydroxyl- or alkyloxy group at the ortho or meta position of a phenolic compound did demonstrate a sufficient thermal stability with time by having a viscosity greater than 100 cP at 100/s and 177° C. in 30 minutes.

### Example 7

1.5 mL/L of a zirconium crosslinker was added to a 6.3 g/L of a hydrated linear polymer gel based on 6 g/L CMHPG, 2 weight percent of potassium chloride (KCl), 2 mL/L surfactant and 1 mL/L of tetraethylene pentamine (TEPA). 0.12 g/L Sesamol was also added to the solution to compare with the one without stabilizer. The viscosity of the sample was measured at 177° C. (350° F.). The results for Example 7 are shown in FIG. 8.

As shown in FIG. 8, the gel without the phenol stabilizer had viscosity less than 50 cP at 100/s and 177° C. in less than 30 mins (about 26 minutes). The same gel in presence of the phenol stabilizer used in Example 7 (sesamol, which has a formula of formula (1)) did demonstrate a sufficient thermal stability with time by having a viscosity greater than 100 cP at 100/s and 177° C. in 30 minutes. Furthermore, the gel in the presence of sesamol is as stable as the gel in the presence of sodium thiosulfate.

Although only a few example embodiments have been described in detail above, those skilled in the art will readily appreciate that many modifications are possible in the example embodiments without materially departing from HIGH TEMPERATURE STABILIZER FOR POLYMER BASED TREATMENT FLUIDS. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function

What is claimed is:

1. A method of treating a subterranean formation, the method comprising:
forming a fluid comprising:
a crosslinkable component and
a water soluble phenolic compound that has at least a substituted hydroxyl or alkyloxy group at the ortho or meta position, or a phenolic cyclic derivative of the general formula (1) 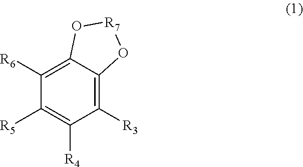
wherein R₇ is an alkyl chain with 1 to about 5 atoms, which may further incorporate heteroatoms, and
wherein R₃, R₄, R₅, and R₆ can independently be hydrogen atoms, hydroxyl groups, alkyl chains, alkene chains, esters, alcohols, aldehydes, aromatic compounds or combinations thereof, and
wherein the formed fluid comprising a combination of the crosslinkable component and the phenolic compound or the phenolic cyclic derivatives of formula 1 exhibits a fluid viscosity greater than 100 cP at 100/s and 93° C. or greater for at least 30 minutes.

2. The method of claim 1, wherein the crosslinkable component is selected from the group consisting of guar, guar derivatives, polyacrylamide, partially hydrolyzed polyacrylamide (PHPA), copolymers of acrylamide and acrylic acid, neutralized copolymers of acrylamide and acrylic acid, copolymers of acrylamide and sodium acrylate, partially hydrolyzed polyacrylamide, copolymers of acrylamide and AMPS, cationic polyacrylamides, vinylpyrrolidone, or a combination thereof.

3. The method of claim 1, wherein the crosslinkable component is crosslinked.

4. The method of claim 1, wherein the water solubility of the phenolic compound or phenolic derivative is greater than 10 mg/L.

5. The method of claim 1, wherein the fluid further comprises a borate ion.

6. The method of claim 1, wherein the fluid further comprises a metal crosslinker.

7. The method of claim 6, wherein the metal crosslinker comprises zirconium, aluminum, titanium, and/or other Group IV metals.

8. The method of claim 1, wherein the water soluble phenolic compound is selected from the group consisting of methoxyphenol, ethoxyphenol, propoxyphenol, butoxyphenol, dimethoxyphenol, trimethoxyphenol, dihydroxy-methoxybenzene, dihydroxy-dimethoxybenzene, trihydroxyphenol, methoxy-methylphenol, allyl methoxyphenol, allyl dimethoxyphenol, rutin hydrate, epigallocatechin, epicatechin and 5-(3′4′5′-trihydroxyphenyl)-γ-valerolactone.

9. The method of claim 1, wherein the water soluble phenolic compound is a phenolic cyclic derivative selected from the group consisting of 1,3-benzodioxole, benzo-1,4-dioxane, 2,3-Dihydro-1,4-benzodioxin-5-ol, 5-methoxy-1,3 -benzodioxole, 5,6-Dihydroxy-1,3-benzodioxole, sesamol, 5-methyl-1,3-benzodioxole, sesamin, piperonyl alcohol, piperonal, and 3, 4-methylenedioxy aniline.
